(19) United States
(12) Patent Application Publication
(10) Pub. No.: US 2024/0095317 A1
(43) Pub. Date: Mar. 21, 2024

(54) Method and System For Device Access Control

(71) Applicant: APPLE INC., Cupertino, CA (US)

(72) Inventor: Kevin M. Lynch, Woodside, CA (US)

(21) Appl. No.: 18/221,245

(22) Filed: Jul. 12, 2023

Related U.S. Application Data
(60) Provisional application No. 63/406,912, filed on Sep. 15, 2022.

(51) Int. Cl. G06F 21/31

(52) U.S. Cl. CPC G06F 21/31

(57) ABSTRACT

A method includes obtaining sensor information from one or more sensors of the mobile device, analyzing the sensor information to determine a first identifier for a person, determining whether the person is authorized to use the mobile device based on a comparison of the first identifier to previously stored authentication information, and in response to determining that the person is authorized to use the mobile device, outputting a recognition indicator.

### CROSS-REFERENCE TO RELATED APPLICATIONS

This application claims the benefit of and priority to U.S. Provisional Application No. 63/406,912, filed on Sep. 15, 2022, the content of which is hereby incorporated by reference herein in its entirety for all purposes.

### FIELD

The present disclosure relates generally to the field of recognizing users at a device.

### BACKGROUND

Some devices require a user to perform an action in order to establish that they are authorized to use the device, such as using a physical key or providing a password to the device.

### SUMMARY

One aspect of the disclosure is a method that includes obtaining sensor information from one or more sensors of a transport device, analyzing the sensor information to determine a first identifier for a person, determining whether the person is authorized to use the transport device based on a comparison of the first identifier to previously stored authentication information, and in response to determining that the person is authorized to use the transport device, outputting a recognition indicator.

The recognition indicator may be output according to customization information that is stored in a user profile that is associated with the person. Outputting the recognition indicator may include outputting at least one of an audible indicator or a visible indicator. Outputting the recognition indicator may include causing motion of a transport device body of the transport device according to a predetermined motion pattern using one or more suspension actuators. The predetermined motion pattern may include at least one of vibrating the transport device body, raising the transport device body, lowering the transport device body, or rotating the transport device body with respect to one or more axes of rotation. In some implementations, outputting the recognition indicator includes transmitting a recognition signal to a user device that is associated with the person, wherein the recognition signal causes the recognition indicator to be output by the user device, and the recognition signal further causes the user device to output an entry control prompt, and the entry control prompt is configured to accept a user input that commands the transport device to perform an entry control action.

The method may also include analyzing the sensor information to determine a second identifier for the person, wherein determining whether the person is authorized to use the transport device is based further on a comparison of the second identifier to the previously stored authentication information. In some implementations, the first identifier is a biometric identifier, and the second identifier is a non-biometric identifier. In some implementations, the first identifier is a first biometric identifier, and the second identifier is a second biometric identifier.

The sensor information may include one or more images that are obtained from a camera. The sensor information may include a signal received from a user device that is associated with the person. The sensor information may include a verbal statement made by the person that is obtained from a microphone. The sensor information may include facial recognition information for the person. The first identifier may include facial recognition information for the person. The first identifier may include body recognition information for the person. The first identifier may include gait recognition information for the person. The first identifier may include voice recognition information for the person. In some implementations, the previously stored authentication information is previously obtained using one or more sensors of a user device that is associated with the person. In some implementations, outputting the recognition indicator is performed while all doors of the transport device remain closed and locked.

Another aspect of the disclosure is a non-transitory computer-readable storage device including program instructions executable by one or more processors that, when executed, cause the one or more processors to perform operations. The operations include obtaining sensor information from one or more sensors of a transport device, analyzing the sensor information to determine a first identifier for a person, determining whether the person is authorized to use the transport device based on a comparison of the first identifier to previously stored authentication information, and in response to determining that the person is authorized to use the transport device, outputting a recognition indicator.

Another aspect of the disclosure is an apparatus that includes a memory and one or more processors that are configured to execute instructions that are stored in the memory. The instructions, when executed, cause the one or more processors to obtain sensor information from one or more sensors of a transport device, analyze the sensor information to determine a first identifier for a person, determine whether the person is authorized to use the transport device based on a comparison of the first identifier to previously stored authentication information, and in response to determining that the person is authorized to use the transport device, output a recognition indicator.

### BRIEF DESCRIPTION OF THE DRAWINGS

FIG. 1 is a block diagram of a system according to an example.

FIG. 2 is a block diagram of a transport device according to an example.

FIG. 3 is a schematic illustration of a person and the transport device in an environment according to an example.

FIG. 4 is a block diagram of a process for providing access to the transport device according to an example.

FIG. 5 is a block diagram of an authorization operation according to an example.

FIG. 6 is a block diagram of an authorization operation according to an example.

FIG. 7 is a block diagram of a computing device according to an example

### DETAILED DESCRIPTION

The disclosure herein relates to systems in which a transport device is configured to recognize that an authorized user is present in the environment around the transport device, and respond to the presence of the authorized user. The user may be recognized by a biometric identifier and/or a non-biometric identifier. The recognition indicator may be a visual indicator and/or an audible indicator that is output at the transport device or at a user device. Entry control actions may be taken subsequent to output of the recognition indicator. For example, the entry control actions may include automatically unlocking and/or opening one or more doors in response to a user expression of intention to use the transport device.

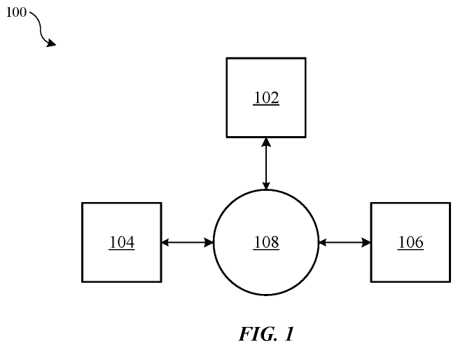

FIG. 1 is a block diagram of a system 100 that includes a transport device 102, a user device 104, and a service 106. The transport device 102, the user device 104, and the service 106 are configured to communicate with each other, for example, by transmission of signals and/or data, using a network 108. The network 108 is a communications network that allows wired and/or wireless communications connections to be established between devices. The network 108 may be or include local area networks, the Internet, and/or direct communications using any type of short range communications system.

The user device 104 may be a smart cellular phone or another type of electronic device that may be carried by a user. As an example, the user device 104 may be able to receive information from a user, provide information to the user, and communicate with the transport device 102 and/or the service 106. The user device 104 may be associated with an authorized user of the transport device 102. The user device 104 may be associated with a person who is located near the transport device 102, and who may or may not be authorized to use the transport device 102. In some implementations, multiple devices equivalent to the user device 104 are used, such as a first device that is associated with an authorized user of the transport device 102 and a second device that is associated with a person who is located near the transport device 102. In some implementations, the user device 104 employs exemplary computing device 770 described with reference to FIG. 7, below.

The service 106 may communicate with the transport device 102 and the user device 104 to facilitate certain aspects of use of the transport device 102 by a user who is associated with the user device 104, as will be explained in detail herein. As an example, the service 106 may be configured to send and receive information, commands, requests, to and from the transport device 102 and the user device 104. As an example, the service 106 may be configured to make determinations relating to the transport device 102 and/or the user device 104. The determinations may be made by the service 106 in response to requests received from the transport device 102 and/or the user device 104, in response to receiving information that indicates that a condition is satisfied, in response to passage of a time period (e.g., having a predetermined duration or a duration that is calculated based on information received by the service 106), and so forth.

In some implementations, with appropriate permission, the service 106 may store a user profile for the user who is associated with the user device 104. The user profile may be used to determine whether the user is authorized to use the transport device 102, by indicating that the user is an owner of the transport device 102 or has been granted permission to use the transport device 102. The user profile may store additional information, such as preferences. Gathering and storage of information in a user profile or other form is only performed with consent from the user, and is optional.

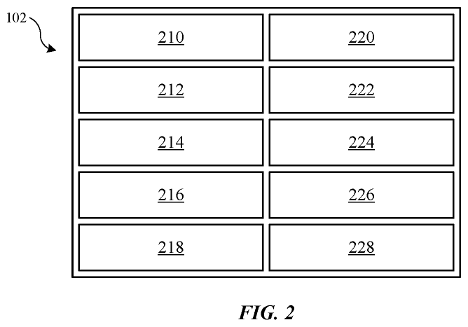

FIG. 2 is a block diagram of an example implementation of the transport device 102. The transport device 102 may be a wheeled vehicle that is configured to travel on roads and on off-road surfaces. The transport device 102 may be configured to carry passengers and/or cargo.

Examples of components that may be included in the transport device 102 include a sensor system 210, an actuator system 212, a human interface device (HID) interface 214, a navigation system 216, a communications system 218, an infotainment system 220, and a drive control system 222. These components are attached to and/or form parts of a physical structure of the transport device 102, such as a body or frame, and are electrically interconnected to allow transmission of signals, data, commands, etc., between them, either over wired connections, (e.g., using a wired communications bus) or over wireless data communications channels. Other components may be included in the transport device 102, including chassis, body, suspension, actuator, power system components, so forth. The structural components of the transport device 102 may define a passenger compartment (e.g., a passenger cabin) and/or a luggage compartment.

The sensor system 210 includes one or more sensor components that are able to collect information that describes an environment around the transport device 102, conditions inside the passenger compartment of the device, and/or information that describes operating conditions of the transport device 102 in order to support functions of the transport device 102 such as autonomous operation by the drive control system 222. The information may be in the form of sensor signals that represent measurements and/or observations. Exemplary sensor components in the sensor system 210 include imaging devices such as still cameras in the visible spectrum or the infrared spectrum, video cameras, Lidar or other depth sensors, Radar sensors, GPS sensors, inertial measurement units, position sensors, angle sensors, speed sensors, torque sensors, force sensors, and so forth.

The actuator system 212 includes one or more actuator components that are able to affect motion of the transport device 102. The actuator components of the actuator system 212 can accelerate, decelerate, steer, or otherwise influence motion of the transport device 102. These components can include suspension actuators, steering actuators, braking actuators, and propulsion actuators (e.g., one or more electric motors).

The HID interface 214 includes components that allow a user to interact with various system of the transport device 102. The HID interface 214 includes input devices and output devices. Examples of HID interface 214 include display screens, touch-sensitive interfaces, gesture interfaces, audio output devices, voice command interfaces, buttons, knobs, control sticks, control wheels, pedals, so forth. The HID interface 214 may allow the user to control the navigation system 216, such as by specifying a destination for the transport device 102.

The navigation system 216 may include location determining functionality, mapping functionality, and route planning functionality. As an example, the navigation system 216 may include a satellite positing system receiver to determine a current location of the transport device 102. The navigation system 216 is also configured to determine and/or display one or more routes from a current location to a destination including display of geographic areas near the one or more routes. The navigation system 216 may be operable to receive a route from the user (e.g., passenger), to receive a route from an external route planning system, or to plan a route based on user inputs. As an example, the navigation system 216 may use a routing algorithm of any type to determine a route from an origin location (e.g., a current location or a user-specified location) to a destination location. The route may be determined locally by the navigation system 216 using an on-board routing algorithm or may be determined remotely (e.g., by a navigation routing server). The route may be stored in any suitable data format, for example, such as a list of map segments or road segments that connect the origin location to the destination location.

The communications system 218 allows signals carrying data to be transmitted from the transport device 102 to remote systems and/or received at the transport device 102 from remote systems. Any suitable communications protocol and/or technology may be utilized to implement the communications system 218, such as cellular protocols. As an example, the communications system 218 allows real-time communications between the transport device 102 and other devices or systems, such as the user device 104 and the service 106. Communications devices that are included in the communications system 218 may function as sensors from the sensor system 210. For example, a communication device from the communication system may receive a signal that is emitted from an external device, such as the user device 104, thereby sensing that the external device is nearby (e.g., obtaining sensor information indicating that the external device is nearby), and optionally receiving information by a transmission from the external device that identifies the external device and/or identifies an identity of the user that is associated with the external device. Thus, obtaining information using the sensor system 210 may include receiving a signal by a device included in the communications system 218.

The infotainment system 220 supports information and entertainment providing functions. Hardware components of the infotainment system 220 may include display screens, audio output devices (e.g., loudspeakers), audio input devices (e.g., microphones), touch or gesture sensing input devices (e.g., implementing capacitance-based touch sensing, video-based gesture sensing, three-dimensional scanning-based gesture sensing, or other sensing modalities), lighting devices, and/or other types of devices. The infotainment system 220 may allow for selection and playback or audio and video content. The infotainment system 220 may allow for selection and presentation of informational content such as news and weather reports. The infotainment system 220 may display navigation related information from the navigation system 216.

The drive control system 222 is configured to control motion of the transport device 102, for example, by controlling of operation of actuators from the actuator system 212. As one example, the drive control system 222 may implement an autonomous control mode in which the actuators from the actuator system 212 are controlled (e.g., according to computer program instructions and based on sensor outputs) to cause motion of the transport device 102 toward a destination (e.g., selected using the navigation system 216). As another example, the drive control system 222 may implement a remote control mode in which commands for controlling operation of some or all functions of the actuators from the actuator system 212 are received from a remote location in response to inputs from a human operator at the remote location. As another example, the drive control system 222 may implement a manual control mode in which a person who is traveling using the transport device 102 controls some or all functions of the actuator system 212 by control inputs made through the HID interface 214. In some implementations, the drive control system 222 employs exemplary computing device 770 described with reference to FIG. 7, below.

The transport device 102 further includes an authorization system 224, a recognition system 226, and an entry control system 228. The authorization system 224 is configured to determine whether persons are authorized to use the transport device 102, and to perform functions relating to this determination, such as registering persons as authorized users and maintaining information that pertains to authorized users. As used herein, an authorized user of the transport device 102 may include an owner of the transport device 102 or a person who has been granted permission to use the transport device 102 by the owner, either directly or indirectly. An output of the authorization system 224, such as a determination that person near the transport device 102 is an authorized user of the transport device 102, can be used to control operation of the recognition system 226 and the entry control system 228.

The recognition system 226 of the transport device is configured to output a recognition indicator. The recognition indicator is a communication mechanism that allows the transport device 102 to indicate, to the user, the fact that the transport device 102 has recognized the user and has recognized the fact that the user is authorized to use the transport device 102, but without unlocking or opening any of the doors of the transport device 102. The recognition indicator may be output, for example, in response to a determination, made by the authorization system 224, that the person who is located near the transport device 102 is an authorized user of the transport device 102.

The entry control system 228 is configured to provide access to the transport device 102, such as by unlocking and/or automatically opening one or more of the doors of the transport device 102. Operation of the entry control system 228 may be controlled by the authorization system 224, so that the entry control system 228 does not provide a person near the transport device with access to the transport device 102 unless the authorization system 224 determines that the person who is located near the transport device 102 is an authorized user of the transport device 102. Providing access to the transport device 102 may further be conditional upon presence of an additional input that indicates that the person wishes to use the transport device 102 (e.g., the person has a present intention to enter and/or use the transport device 102), so that the doors of the transport device 102 are not transitioned to an unlocked position or an open position when the person does not intend to use the transport device 102.

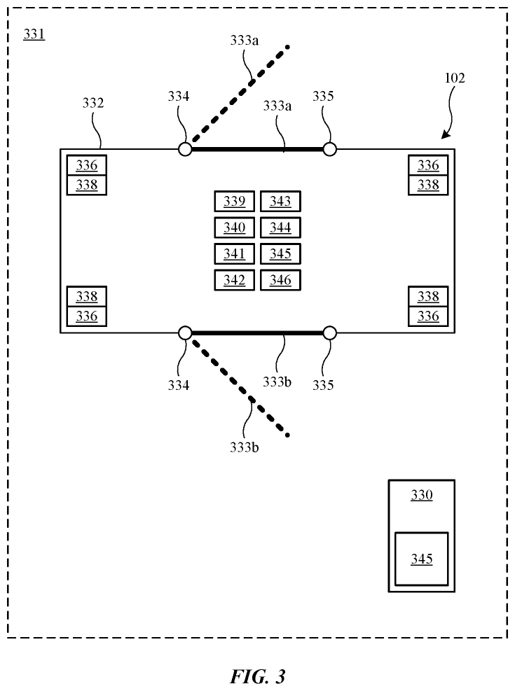

FIG. 3 is schematic illustration of the transport device 102 and a person 330 in an environment 331, and is presented as an example scenario in which the authorization system 224, the recognition system 226, and the entry control system 228 may be used to determine whether and how to react to presence of the person 330 near the transport device 102. As will be explained, reacting to the presence of the person 330 near the transport device 102 may include taking no action (e.g., when the person 330 is not an authorized user), outputting a recognition indicator that shows that the transport device 102 recognizes the person 330 as an authorized user, prompting the person 330 for instructions as to whether to unlock or open the doors of the transport device 102, and unlocking and/or automatically opening one or more doors of the transport device 102.

The transport device 102 includes a transport device body 332 and doors 333a, 333b that are connected to the transport device body 332 for movement between a closed position (sold lines) and an open position (dashed lines) automatically under control of a door movement mechanism 334, and which may be locked and unlocked (e.g., transitioned between a locked state and an unlocked state) by a locking mechanism 335. The locking mechanism 335 prevents unauthorized access to the transport device 102 by locking the doors 333a, 333b, which prevents movement of the doors 333a, 333b from the closed position to the open position, and allows the doors 333a, 333b to be moved to the open position by unlocking. The transport device body 332 of the transport device 102 may be supported by wheels 336 and suspension components 338. The suspension components 338 may include passive suspension components, such as springs, and active suspension actuators (e.g., electric, pneumatic, or hydraulic actuators) that are controllable, for example, to reduce vibrations experienced by the transport device body 332. The transport device 102 may also include one or more cameras 339 and/or one or more three-dimensional sensors 340, which are part of the sensor system 210, and can be used to observe the environment 331 around the transport device 102. The transport device 102 may also include input and output devices, such as one or more microphones 341, one or more touch sensitive input devices 342, one or more audio output devices 343, and one or more a visual output devices 344.

In the illustrated scenario, the person 330 is located in the environment 331 where the transport device 102 is located. The person 330 may be carrying a user device 345. The user device 345 may be equivalent to the user device 104, and may be implemented in a similar manner. In some examples, the user device 345 is a personal device, such as a smart phone or a smart watch, and is specifically associated with the person 330, such as being linked to a user account that is associated with the person 330. In some implementations, the user device 345 is not explicitly associated with the person 330 and instead may be a device that is associated specifically with the transport device 102, such as a key fob.

While the person 330 is located in the environment 331, the transport device 102 may communicate with the user device 345 using a communications device 346 that is an included component of the sensor system 210 and/or the communications system 218. The communications device 346 may transmit information (e.g., in the form of signals and/or data) to and/or receive information from the user device 345. As an example, the communications device 346 may receive a signal from the user device 345 indicating presence of the user device 345 near the transport device 102. As another example, the communications device 346 may receive a signal from the user device 345 indicating a location of the user device 345. The position of the user device 345 may be detected at the user device 345 using satellite positioning or other location determining techniques. The user device 345 may transmit of geospatial coordinates or other position information to the communications device 346. As another example, the communications device 346 may detect presence of the user device 345 using wireless ranging signals.

While the person 330 is located in the environment 331, the transport device 102 may observe the person 330 to determine whether the person 330 is an authorized user of the transport device 102 and/or whether the person 330 intends to use the transport device 102. These observations are performed using one or more sensors from the sensor system 210 or another system of the transport device 102. These observations of the person 330 in the environment 331 relate to the appearance, movement, behavior, and actions of the person 330 in the environment, and are separate from information sent to, received from, or otherwise based on communications with the user device 345.

The sensors used by the transport device 102 to observe the environment 331 may include one or more cameras 339, one or more three-dimensional sensors 340, and one or more microphones 341. These components may be part of the sensor system 210. The cameras 339 may be still cameras or video cameras that are configured to obtain visible spectrum images and/or infrared spectrum images. The three-dimensional sensors 340 may include lidar sensors, ultrasonic sensors, depth cameras, structured light sensors, or types of other three-dimensional sensors. The microphones 341 may be conventional audio input devices of any type. In addition to being used to observe the environment 331 around the transport device 102 (e.g., when the transport device 102 is parked and not in use), the cameras 339, the three-dimensional sensors 340, and the microphones 341 may be used to obtain sensor outputs (e.g., images, point clouds, audio signals, etc.) that are analyzed by the drive control system 222 and used as inputs for functions such as lane detection and object detection while the transport device 102 is being operated under control of the drive control system 222 as part of the autonomous control mode of the drive control system 222.

The system 100 and/or the transport device 102 may be configured to perform processes in support of determining whether a person is authorized to use the transport device 102 and communicating recognition of authorization from the transport device 102 to the person 330. Such processes can be implemented using one or more computing devices, such the computing device 770 of FIG. 7. As an example, the processes described herein and the steps thereof may be implemented in the form of computer program instructions that are executable by one or more computing devices, wherein the instructions, when executed by the one or more computing devices, cause the one or more computing devices to perform functions that correspond to the steps of the processes. The implementations described herein are examples. The processes described herein and the features of them may be combined with one another, as will be understood by persons of skill in the art.

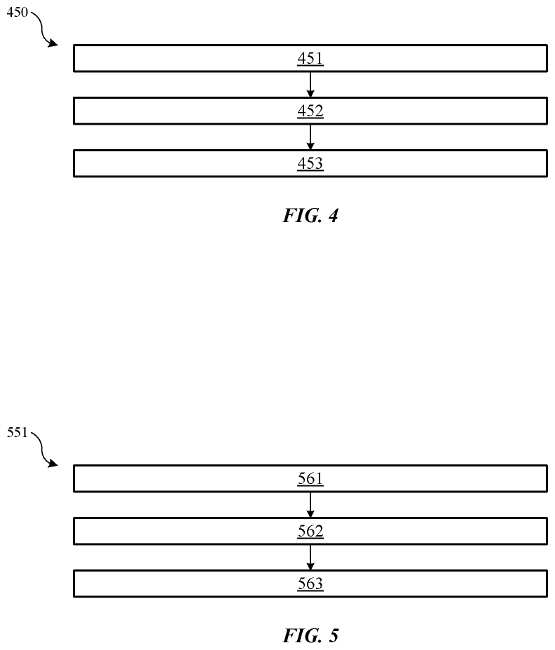

FIG. 4 is a block diagram that shows a process 450 for providing access to the transport device 102. The process 450 includes an authorization operation 451, a recognition operation 452, and an entry control operation 453.

The authorization operation 451 may be performed by the authorization system 224. In the authorization operation 451, a determination is made as to whether the person 330 is authorized to use the transport device 102. Thus, the authorization operation 451 may include determining, by the transport device 102, whether the person 330 is authorized to use the transport device 102. This determination may be made based on communications between the transport device 102 and the user device 345, and/or based on observations of the person 330 made by one or more sensors of the transport device 102, such as the communications device 346, the cameras 339, the three-dimensional sensors 340, and the microphones 341.

The determination made in the authorization operation 451 may be made using previously stored authentication information. The previously stored authentication information is available to the transport device 102 for use in the process 450 and may be stored at the system 100 and/or at the transport device 102. The previously stored authentication information is stored prior to a specific occurrence of an authentication determination. For example, the previously stored authentication information may be stored during a setup process in which the person 330 creates a user profile and links it to an authorization to use the transport device 102, or in which the person 330 identifies a previously established user profile and links it to an authorization to use the transport device 102. Thus, for example, the previously stored authentication information may be previously obtained using one or more sensors of a user device that is associated with the person 330, such as the user device 345.

The result of the authorization operation 451 may be an indication that the person 330 is authorized to use the transport device 102. In response to the indication that the person 330 is authorized to use the transport device 102, the process 450 proceeds to the recognition operation 452. Otherwise, the authorization operation 451 may be repeated. A further result of the authorization operation 451 may be information that identifies the person 330, such as a name of the person 330 or an identification of a user account that is associated with the person 330. This information may be passed to the recognition system 226 for use in performance of the recognition operation 452 and may further be provided to the entry control system 228 for use in performance of the entry control operation 453.

The authorization operation 451 occurs without action by the user. For example, the user does not act to initiate the authorization operation 451, such as by pressing a button. Instead, the authorization operation 451 may be performed continuously by the transport device 102, or may be performed in response to a stimulus, such as detecting motion or sound near the transport device 102, as will be described further. Thus, the authorization operation 451 may be initiated by the transport device 102 instead of in response to a user action.

The recognition operation 452 may be performed by the recognition system 226. In the recognition operation 452, the recognition indicator is a mechanism by which the transport device 102 communicates with the person 330, allowing the transport device 102 to indicate that the person 330 has been recognized as an authorized user of the transport device 102. The recognition indicator also indicates to the person 330 that the transport device 102 is standing by to take further actions that provide the person 330 with access to the transport device 102 if the person intends to enter and/or use the transport device 102. The recognition indicator may be output without the person 330 taking an explicit action of the type that would cause the transport device 102 to unlock and or open the doors 333a, 333b (e.g., pressing a button on a key fob or a door handle), and instead may be output while the person 330 is present near the transport device 102 and/or while the person 330 is approaching the transport device 102. The recognition operation 452 is separate from unlocking and/or opening the doors 333a, 333b of the transport device 102, and may instead be performed while all doors of the transport device 102, such as the doors 333a, 333b, remain closed and locked.

Outputting the recognition indicator in the recognition operation 452 may include outputting at least one of an audible indicator or a visible indicator. The transport device 102 causes the recognition indicator to be output, and output of the recognition indicator can occur at the transport device 102 or at another device that is external to the transport device 102, such as the user device 345.

The recognition indicator may be a predetermined recognition indicator that is selected by the person 330 in advance, for example, as part of a setup process, and stored as customization information in a user profile that is associated with the person 330. Thus, the recognition indicator may be output according to customization information that is stored in a user profile that is associated with the person 330. This customization information may select one or more types of indicators that are included in the recognition indicator. The customization information may include context-sensitive rules. For example, use audible indicators may be omitted or substituted with visible indicators at certain times of day (e.g., late at night) or at certain locations (e.g., with the location of the transport device 102 being determined by satellite positioning or another location determining technique). Thus, outputting the recognition indicator in the recognition operation 452 may include selecting the recognition indicator using customization information from a user profile that is associated with the person 330.

In some implementations, the recognition indicator is output at the transport device 102 in the form of an audible indicator or a visible indicator that emanates from a component of the transport device 102 as its source. As examples, the transport device 102 may output the recognition indicator using one or more of the audio output devices 343, such as loudspeakers, the visual output devices 344, such as lights or display screens, and the suspension components 338. Using the audio output devices 343, the transport device 102 can output audio that can be heard by the person 330.

In some implementations, active suspension actuators from the suspension components 338 of the transport device 102 are used to output the recognition indicator. The transport device 102 may control operation of the active suspension actuators to cause motion of the transport device body 332 of the transport device 102 with respect to the wheels 336 of the transport device 102 (e.g., by moving in place without relocating to a different position in the environment 331). Thus, outputting the recognition indicator may include causing motion of the transport device body 332 of the transport device 102 using one or more suspension actuators from the suspension components 338. In addition, outputting the recognition indicator may include causing motion of the transport device body 332 of the transport device 102 according to a predetermined motion pattern using one or more suspension actuators from the suspension components 338. As examples, the predetermined motion pattern that is used to output the recognition indicator may include at least one of vibrating the transport device body 332 using one or more suspension actuators from the suspension components 338, raising and/or lowering the transport device body 332 using one or more suspension actuators from the suspension components 338, or rotating the transport device body 332 with respect to one or more axes of rotation using one or more suspension actuators from the suspension components 338. As another example, the predetermined motion pattern may include changing the steering angle of one or more of the wheels 336, for example, using steering actuators that are each associated with one or more of the wheels. In a further example, an independently controllable steering actuator is associated with each of the wheels 336 independent of other ones of the wheels 336. In such as implementation two or more of the wheels 336 may be concurrently rotated between different steering angles independent of each other, such as by rotating the left and right front wheels inward toward each other or outward away from each other.

In some implementations, the recognition indicator is output at a device that is external from the transport device 102, such as the user device 345. As an example, the transport device 102 may use the communications device 346 to transmit a recognition signal to the user device 345 that is associated with the person 330, and the recognition signal, when processed by the user device 345, causes the recognition indicator to be output by the user device 345. As an example, the user device 345 may be a smart watch, and the recognition indicator may be output by the smart watch using an audio output device (e.g., a loudspeaker) and/or a visual output device (e.g., a display screen) such as by playing a sound and/or displaying a message indicating that the person 330 has been recognized by the transport device 102.

The entry control operation 453 may be performed by the entry control system 228. The entry control operation 453 is performed subsequent to determining that the person 330 is authorized to use the transport device 102 in the authorization operation 451, and may occur subsequent to performing the recognition operation 452. In the entry control operation 453, a determination is made as to whether to unlock one or more of the doors 333a, 333b of the transport device 102 and/or whether to automatically open one or more of the doors of the transport device 102.

In some implementations, the entry control operation 453 may include detecting, subsequent to outputting the recognition indicator, an expression of an intention to enter the transport device by the person 330, which may be performed using one or more sensors of the transport device 102. In response to the expression of the intention to enter the transport device 102, the transport device 102 may perform one or more entry control actions. Examples of entry control actions include unlocking a door of the transport device 102 using the locking mechanism 335 and/or may automatically opening a door of the transport device 102 using the door movement mechanism 334. As examples, the expression of the intention to enter the transport device 102 may include at least one of a spoken command sensed by the microphones 341, a gesture sensed using the cameras 339 or the three-dimensional sensors 340, or contact with a portion of the transport device 102, such as one of the touch sensitive input devices 342, which may be incorporated in an exterior surface of the transport device 102 (e.g., a panel surface) independent of a mechanical button or other explicit input device.

In implementations of the entry control operation 453 that include use of a spoken command as an expression of intention to enter the transport device 102, the spoken command may specify one or more entry control actions. As examples, the spoken command may indicate which of the doors 333a, 333b is to be opened, may request opening of a cargo area (e.g., by opening a trunk lid), may request deployment of a ramp, may request deployment of stairs, may request a particular seating configuration, and so forth.

In implementations in which the recognition indicator of the recognition operation 452 is output at a device that is external from the transport device 102, such as the user device 345, by transmission of the recognition signal to the user device 345, the recognition signal may cause the user device 345 to output an entry control prompt. The entry control prompt may be output using a display device (e.g., as a message and/or button on a display screen) of the user device 345 or may be output as an audio prompt. The entry control prompt may ask which of several entry control actions should be taken, or may ask whether a specific entry control action should be taken. The person 330 may respond to an on-screen entry control prompt by selecting an option by providing an input, for example, a touch input or a button press. The person 330 may respond to an audio entry control prompt with a spoken command as previously described. As one example, the entry control prompt may be a door opening prompt that asks whether a specific door should be opened and the person 330 may select a response (e.g., yes or no) by a manual input (e.g., touch or press) or a verbal input. Thus, outputting the recognition indicator may include transmitting a recognition signal to the user device 345 that is associated with the person 330, wherein the recognition signal causes the recognition indicator to be output by the user device 345, and the recognition signal may further cause the user device 345 to output an entry control prompt, and the entry control prompt is configured to accept a user input that commands the transport device 102 to perform an entry control action. In response to the user input, the entry control system 228 may cause performance of the selected entry control action that is commanded by the user input.

In one implementation, the entry control actions that may be performed by the entry control system 228 in the entry control operation 453 include selecting one or more of the doors of the transport device 102, and opening the selected doors. As an example, the entry control system 228 may select one of the doors 333a, 333b to be opened based on a distance between the person 330 and each of the doors 333a, 333b by selecting the door that is closest to the person 330, and the entry control system 228 then causes the door movement mechanism 334 to open the selected door. As another example, sensor information can be used to determine that a trajectory of the person 330 is oriented to a specific one of the doors 333a, 333b, and that door is selected to be opened.

Other the entry control actions may be performed by the entry control system 228 in the entry control operation 453. Examples of entry control actions include changing the positions of seats in a passenger cabin of the transport device 102, changing lighting settings in the passenger cabin of the transport device 102, and changing settings of the infotainment system 220 (e.g., by playing specific music or tuning to a particular radio frequency). These entry control actions may be user specific and may be determined based on the identity of the person 330, such as by accessing stored settings that are associated with the user. As an example, the stored settings may be part of a user profile for the person 330.

In some implementations, the entry control actions that can be performed by the entry control system 228 include moving the transport device 102 from a current location (e.g., a parking space) to a location of the person 330 (e.g., a loading area). As an example, the recognition signal can be sent from the transport device 102 to the user device 345 and output the recognition indicator so that it includes an entry control prompt that allows the user to direct the transport device 102 to move to the location of the person 330. In response to this request from the user, the drive control system 222 may use the autonomous control mode to control operation of the transport device 102 so that the transport device 102 moves (e.g., by driving autonomously) from the current location of the transport device 102 to the location of the person 330.

FIG. 5 is a block diagram that shows a process 551, which is a first example implementation of the authorization operation 451. In the process 551, sensor information is obtained in operation 561 and analyzed in operation 562. The result of this analysis is used to determine whether the person 330 is authorized to use the transport device 102 in operation 563.

Operation 561 includes obtaining sensor information from one or more sensors of the transport device 102. The sensors used in operation 561 may include sensors from the sensor system 210 and/or other sensors included in the transport device 102. The sensor information obtained in operation 561 may include images, three-dimensional data such as a point cloud, signals received from nearby external devices, audio recordings, or other information that includes or represents an observation of the environment 331 around the transport device 102.

As an example, the sensor information obtained in operation 561 may include one or more images that are obtained from the cameras 339 and show the environment 331. These images may include a representation of the person 330 if the person 330 is located in the environment 331 within a field of view of the cameras 339. Multiple images may be captured over time, such as a series of still images or a series of video frames, to allow detection and tracking of moving objects in the environment 331.

As another example, the sensor information obtained in operation 561 may include three-dimensional information that is obtained from the three-dimensional sensors 340 and include a representation of the environment 331, for example, in the form of information identifying the locations of surfaces that are present in the environment 331. This information may be referred to as a three-dimensional scan of the environment. The three-dimensional information may include a representation of the person 330 if the person 330 is located in the environment 331 within a field of view of the three-dimensional sensors 340. Multiple three-dimensional scans of the environment 331 may be captured over time, to allow detection and tracking of moving objects in the environment 331.

As another example, the sensor information that is obtained in operation 561 may include an audio signal that is obtained using an audio input device, such as the microphones 341. The audio signal may include a verbal statement made by the person 330 while present in the environment 331 near the transport device 102.

As another example, the sensor information that is obtained in operation 561 may include a signal that is received from a nearby device, such as the user device 345. The user device 345 may be a personal device that is associated with the person 330, or a device that is associated with the transport device 102 and is not specifically linked to the person 330 (e.g., linked in a manner that implies that presence of the user device 345 is highly correlated with presence of the person 330, such as by an authentication process performed by the device).

In some implementations, obtaining sensor information in operation 561 is implemented in a two-stage process. The first stage of the two-stage process is performed using a first type of sensor from the transport device 102, and the second stage of the two-stage process is performed using a different type of sensor that is not used in the first stage. The two stage process allows the transport device 102 to observe the environment 331 while using less power, for example, by using sensors during the first stage that have a lower power draw requirement than the sensors that are used in the second stage. In the first stage, sensors are used to make environment observations that are intended to determine whether there is movement (e.g., by one or more persons) in the environment 331 around the transport device 102. This may be performed by sensors from the sensor system 210, such as ultrasonic sensors, infrared emitters and infrared sensors, or the microphones 341. The first stage of the sensing process may be performed continuously until motion is detected. In response to detecting movement, the transport device 102 activates at least one additional sensor to observe the environment 331, such as the cameras 339 or the three-dimensional sensors 340. These sensors are used to make observations according to the previous description of operation 561. The second stage of the sensing process may continue until motion near the transport device 102 ceases, until a predetermined period of time passes, or until another condition is met, at which point operation returns to the first stage of the two-stage sensing process.

Subject to user approval as discussed below, operation 562 includes analyzing the sensor information that was obtained in operation 561 to determine an identifier for the person 330 who is located in the environment 331 around the transport device 102. The identifier is information that can be used as a basis for determining the identity of the person 330. As will be explained further, the identifier may be implemented in multiple forms, and may be derived from multiple types of information. As an example, the identifier may be a biometric identifier that is determined based on observation and analysis of the body of the person 330, or the identifier may be a non-biometric identifier that is not determined based on observation and analysis of the body of the person 330, but instead is derived for data provided by another source, such as the user device 345.

Operation 563 includes determining whether the person 330 is authorized to use the transport device 102 based on the identifier that was determined by the analysis performed in operation 562. Determining whether the person 330 is authorized to use the transport device 102 may be based on a comparison of the identifier determined in operation 562 to previously stored authentication information. As an output, the transport device 102 may determine, in operation 563, that the person 330 is authorized to use the transport device 102, or that the person 330 is not authorized to use the transport device 102. This indication may be passed to another system or operation, such as to the recognition system 226 for performance of the recognition operation 452 of the process 450.

The previously stored authentication information that is used in operation 563 is stored prior to performance of the process 551, for example, during a set up procedure that occurred in the past (e.g., days, weeks, or months before a performance of the process 551) in which user(s) have provided appropriate approval. Thus, the previously stored authentication information was stored prior to entry of the person 330 in to the environment 331 for the purpose of the current approach toward the transport device 102 and the corresponding action by the transport device 102 of obtaining sensor information in operation 561.

Subject to user approval as discussed below, in some implementations of the process 551, the identifier that is determined in operation 562 includes facial recognition information for the person 330. The facial recognition information is a biometric identifier that includes an encoding of the features (e.g., appearance, structure, sizes of facial features, positions of facial features) of the face of the person 330 in a form that allows the person 330 to be identified by comparison of the encoding that is generated according to operations 561 and 562 with previously stored facial recognition information (e.g., a previously stored encoding of the person's facial features) in operation 563. The previously stored facial recognition information is stored prior to the current analysis, with consent obtained from the person 330, and is either stored at the transport device 102 or at another system that provides the information to the transport device 102 or performs the comparison for the transport device 102, such as the system 100. Authorization may be determined in operation 563 based on the facial recognition information alone, or based on the facial recognition information in combination with another identifier.

In one implementation of facial recognition, subject to appropriate user privacy considerations, the sensor information that is obtained in operation 561 may include one or more images that are obtained from the cameras 339, and the images are analyzed to determine the facial recognition information in operation 562. In another implementation of facial recognition, the sensor information that is obtained in operation 561 includes one or more three-dimensional scans that are obtained from the three-dimensional sensors 340, and the three-dimensional scans are analyzed to determine the facial recognition information in operation 562. Facial recognition information can be determined according to known machine vision and/or geometric analysis techniques, including processing the images or three-dimensional scans that were obtained in operation 561 using a trained machine learning model to determine the facial recognition information.

Subject to user approval as discussed below, in some implementations of the process 551, the identifier that is determined in operation 562 includes body recognition information for the person 330. The body recognition information is a biometric identifier that includes an encoding of the features (e.g., appearance, structure, sizes of body features, positions of body features) of the body of the person 330 in a form that allows the person 330 to be identified by comparison of the encoding that is generated according to operations 561 and 562 with previously stored body recognition information (e.g., a previously stored encoding of the person's body features) in operation 563. As an example, the encoded body recognition information may include joint locations and lengths of body portions (e.g., length of upper portion of leg, length of lower portion of leg, length of upper portion arm, length of lower portion of arm, torso length and width, etc.) The previously stored body recognition information is stored prior to the current analysis, with consent obtained from the person 330, and is either stored at the transport device 102 or at another system that provides the information to the transport device 102 or performs the comparison for the transport device 102, such as the system 100. Authorization may be determined in operation 563 based on the body recognition information alone, or based on the body recognition information in combination with another identifier.

In one implementation of body recognition, the sensor information that is obtained in operation 561 includes one or more images that are obtained from the cameras 339, and the images are analyzed to determine the body recognition information in operation 562. In another implementation of body recognition, the sensor information that is obtained in operation 561 includes one or more three-dimensional scans that are obtained from the three-dimensional sensors 340, and the three-dimensional scans are analyzed to determine the body recognition information in operation 562. Body recognition information can be determined according to known machine vision and/or geometric analysis techniques, including processing the images or three-dimensional scans that were obtained in operation 561 using a trained machine learning model to determine the body recognition information.

Subject to user approval as discussed below, in some implementations of the process 551, the identifier that is determined in operation 562 includes gait recognition information for the person 330. The gait recognition information is a biometric identifier that includes an encoding of features that describe the way that the person 330 walks, such as by describing motion of the knees, the feet, and the shoulders of the person 330 while they are walking. The gait recognition information is stored in a form that allows the person 330 to be identified by comparison of the encoding of the gait recognition information that is generated according to operations 561 and 562 with previously stored gait recognition information (e.g., a previously stored encoding of the person's walking motion) in operation 563. The previously stored gait recognition information is stored prior to the current analysis, with consent obtained from the person 330, and is either stored at the transport device 102 or at another system that provides the information to the transport device 102 or performs the comparison for the transport device 102, such as the system 100. Authorization may be determined in operation 563 based on the gait recognition information alone, or based on the gait recognition information in combination with another identifier.

In some implementations, the sensor information that is obtained in operation 561 includes one or more images that are obtained from the cameras 339, and the images are analyzed to determine the gait recognition information in operation 562. In some implementations, the sensor information that is obtained in operation 561 includes one or more three-dimensional scans that are obtained from the three-dimensional sensors 340, and the three-dimensional scans are analyzed to determine the gait recognition information in operation 562. Gait recognition information can be determined according to known machine vision and/or geometric analysis techniques, including processing the images or three-dimensional scans that were obtained in operation 561 using a trained machine learning model to determine the gait recognition information.

Subject to user approval as discussed below, in some implementations of the process 551, the identifier that is determined in operation 562 includes voice recognition information for the person 330. The voice recognition information is a biometric identifier that includes an encoding of features that describe the way that the person 330 speaks, and is usable to determine the identity of the person who is speaking based on characteristics of the way that they speak. The voice recognition information is stored in a form that allows the person 330 to be identified by comparison of the encoding of the voice recognition information that is generated according to operations 561 and 562 with previously stored voice recognition information (e.g., a previously stored encoding of the person speaking) in operation 563. The previously stored voice recognition information is stored prior to the current analysis, with consent obtained from the person 330, and is either stored at the transport device 102 or at another system that provides the information to the transport device 102 or performs the comparison for the transport device 102, such as the system 100. Authorization may be determined in operation 563 based on the voice recognition information alone, or based on the voice recognition information in combination with another identifier.

To implement voice recognition, the sensor information that is obtained in operation 561 includes an audio signal that includes a recording of the person 330 speaking, and the audio recording is analyzed to determine the voice recognition information in operation 562. The verbal content of the speech of the person 330 need not include any particular words or phrases, and instead, the analysis used to determine the voice recognition information may be text-independent. Voice recognition information can be determined according to known techniques, such as pattern matching techniques including frequency estimation, hidden Markov models, Gaussian mixture models, pattern matching algorithms, neural networks, matrix representations, vector quantization and decision trees, and trained machine learning models. As an example, the speech recognition information may be stored in the form of a voice print.

In some implementations of the process 551, the identifier that is determined in operation 562 includes authentication information for the person 330. The authentication information may be received at the transport device 102 from the user device 345 that is associated with the person 330. The authentication information indicates to the transport device 102 that the user device 345 is located near that transport device 102, and allows the transport device 102 to determine that the person 330 is authorized to use the transport device 102. The authentication information may identify the person 330 and/or a user account that is associated with the person 330. The authentication information that is transmitted to the transport device 102 is analyzed in operation 563 to determine whether it represents a valid authorization to use the transport device 102, and if so, an indication of authorization can be output as previously described. Authorization may be determined in operation 563 based on presence of the authentication information alone, or based on presence of the authorization information in combination with another identifier.

In some implementations, to allow transmission of authentication information to be transmitted from the user device 345 to the transport device 102, the user device 345 must be in an unlocked state as a result of an authentication process performed at the user device 345 to verify that the person 330 is using the user device 345. Subject to user approval as discussed below, the authentication information performed at the user device 345 may include, as examples, face recognition, fingerprint recognition, submission of a password, or other authentication step that transitions the user device 345 from a locked state, in which some functions of the user device 345 are not available, to an unlocked state, in which those functions are made available as a result of the authentication. Authentication at the user device 345 may be required as a prerequisite for transmission of the authentication information from the user device 345 to the transport device 102, for example, when the user device 345 is a personal device that is associated with the person 330. As an example, a personal device may allow the person 330, when authenticated at the device, to access information, content, and/or services that are associated with the person 330 and/or with a user account that is associated with the person 330.

In some implementations of the process 551, the identifier that is determined in operation 562 includes a key signal. The key signal may be received at the transport device 102 from the user device 345, which in this implementation is a non-personal device, such as a key fob, that is associated with the transport device 102 and not explicitly associated with the user. For example, in this implementation, the user device 345 may lack ability to authenticate the person 330 and/or provide access to user accounts or other information associated with the person 330. The key signal indicates to the transport device 102 that the user device 345 is located near that transport device 102, and is usable by the transport device 102 to determine whether an authorized user is present near the transport device 102. The key signal that is transmitted to the transport device 102 is analyzed in operation 563 to determine whether it represents a valid authorization to use the transport device 102, and if so, an indication of authorization can be output as previously described. Authorization may be determined in operation 563 based on presence of the key signal alone, or based on presence of the key signal in combination with another identifier.

To summarize, the process 551 may include obtaining sensor information from one or more sensors of the transport device 102, analyzing the sensor information to determine an identifier for the person 330, and determining whether the person 330 is authorized to use the transport device 102 based on a comparison of the identifier to previously stored authentication information. An indicator corresponding to the determination as to whether the person 330 is authorized to use the transport device 102 may be output. The identifier may be a biometric identifier or a non-biometric identifier. The sensor information may include one or more images that are obtained from the cameras 339, one or more three-dimensional scans that are obtained from the three-dimensional sensors 340, a verbal statement made by the person 330 that is obtained from the microphones 341, and/or a signal that is received from the user device 345 that is associated with the person 330. The identifier may include facial recognition information, body recognition information, gait recognition information, voice recognition information, and/or authentication information for the person 330.

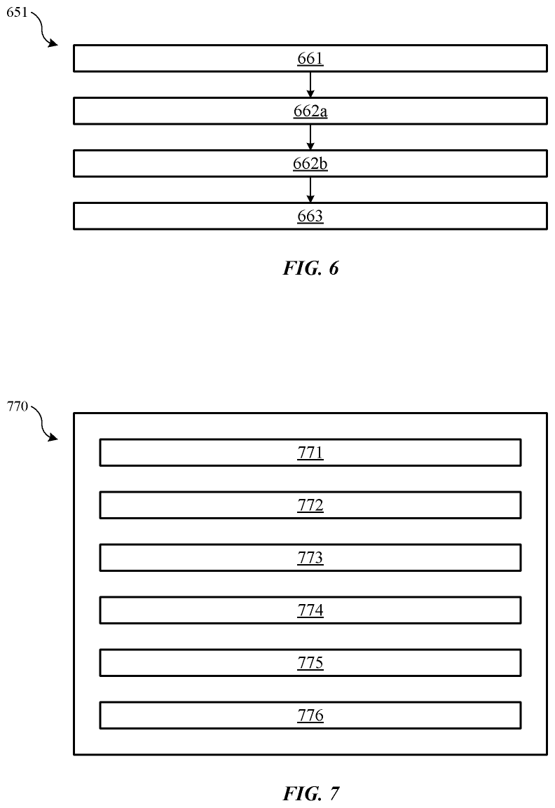

FIG. 6 is a block diagram that shows a process 651, which is a second example implementation of the authorization operation 451. In the process 651, sensor information is obtained in operation 661 and is analyzed in operations 662a and 662b. The result of this analysis is used to determine whether the person 330 is authorized to use the transport device 102 in operation 663.

Operation 661 includes obtaining sensor information from one or more sensors of the transport device 102, and is implemented in the manner described with respect to operation 561 of the process 551. Operation 662a includes analyzing the sensor information that was obtained in operation 661 to determine a first identifier for the person 330 who is located in the environment 331 around the transport device 102. Operation 662b includes analyzing the sensor information that was obtained in operation 661 to determine a second identifier for the person 330 who is located in the environment 331 around the transport device 102. Operations 662a and 662b are implemented in the manner described with respect to operation 562 of the process 551. Operation 663 includes determining whether the person 330 is authorized to use the transport device 102 based on the first identifier that was determined by the analysis performed in operation 662a and based on the second identifier that was determined by the analysis performed in operation 662b. Determining whether the person 330 is authorized to use the transport device 102 includes a first comparison of the first identifier determined in operation 662a to previously stored authentication information, and a second comparison of the second identifier determined in operation 662b to previously stored authentication information. As an output, the transport device 102 may determine, in operation 663, that the person 330 is authorized to use the transport device 102, or that the person 330 is not authorized to use the transport device 102. In this implementation, determining that the person 330 is authorized to use the transport device 102 requires matching the first identifier to the previously stored authentication information and matching the second identifier to the previously stored authentication information. This indication as to whether the person 330 is authorized may be passed to another system or operation, such as to the recognition system 226 for performance of the recognition operation 452 of the process 450.

In the process 651, the first identifier and the second identifier are different types of identifiers. This allows the transport device 102 to ensure that access to the transport device 102 is not unintentionally provided to a person who is not an authorized user of the transport device 102. In one implementation the first identifier is a biometric identifier, and the second identifier is a non-biometric identifier. The non-biometric identifier may be authentication information that is received from the user device 345. Combining a biometric identifier and a non-biometric identifier allows the transport device 102 to confirm that presence of the user device 345 (or other non-biometric identifier) is accompanied by the person 330. In another implementation, the first identifier is a first biometric identifier, and the second identifier is a second biometric identifier. As an example, the first biometric identifier may be body recognition information and the second biometric identifier may be voice recognition information. This allows the transport device 102 to provide access to the person 330 when the user device 345 is not present while ensuring accurate identification of the person 330.

In another implementation of the process 651, a biometric identifier and a non-biometric are used as the first identifier and the second identifier. The person 330 is identified using the biometric identifier in the analysis of operation 663, but the person 330 does not possess a non-biometric identifier, such as the user device 345. In response a message is sent to a user device that is associated with a different authorized user, and the method asks the different authorized user whether to permit access. This message may include the identity of the person 330 and may include information obtained by the one or more sensors of the transport device 102, such as an image that shows the person 330. The other authorized user may respond by granting permission to access the transport device 102, and this grant of permission functions as the second identifier that can be used in operation 663 of the process 651. Thus, in this implementation, the first identifier is a biometric identifier, no signal is received from a nearby user device, such as the user device 345, and a message is sent to a user device that is associated with a different authorized user (e.g., at a remote location that is not near the environment 331 where the transport device 102 is located) asking whether to permit access, and in response to that message, the different authorized user may transmit the grant of access to the transport device 102.

FIG. 7 is a block diagram that shows a computing device 770 according to an example implementation. In the illustrated example, the computing device 770 includes a processor 771, a memory device 772, a storage device 773, input devices 774, a display device 775, and a communication device 776. These and other components may be interconnected by a system bus or other conventional type of interconnect device.

To execute program instructions, the processor 771 may be implemented in the form of one or more conventional processing devices and/or more or more special-purpose processing devices. Implementations may include one or more central processing units, one or more graphics processing units, one or more application specific integrated circuits, and/or one or more field programmable gate arrays. The memory device 772 provides short-term storage in the form of one or more volatile, high-speed, short-term information storage devices, such as random-access memory modules. Long-term storage of computer program instructions and other data may be provided by the storage device 773, which is a non-volatile information storage device, such as a flash memory module, a hard drive, or a solid-state drive. The input devices 774 allow a user to interact with the computing device, and may include a keyboard, a mouse, a touch-based input device, a non-contact gesture-based input device, an audio input device, a motion tracking device, or other type of input device. The display device 775 allows information to be provided by the user and may be implemented using conventional display technologies. The communication device 776 may implement wired and/or wireless communication with other devices through direct or indirect (e.g., networked) connections.

The computing device 770 is operable to store, load, and execute computer program instructions. When executed by the computing device 770, the computer program instructions cause the computing device to perform operations. The operations that can be performed by the computing device 770 may include obtaining information. Examples of obtaining information include accessing the information from a storage device, accessing the information from short-term memory, receiving a wired or wireless transmission that includes the information, receiving signals from an input device that represent user inputs, and receiving signals from sensors that represent observations made by the sensors. The operations that can be performed by the computing device 770 may include making a determination. Examples of making a determination include comparing a value to a threshold, comparing states to conditions, and making a calculation using data of any type. The operations that can be performed by the computing device 770 may also include transmitting information, for example, to a remote system. The operations that can be performed by the computing device 770 may also include outputting a signal to cause an external device to perform an operation. As examples, a computing device 770 may control a component, cause a sensor to take a measurement, cause a camera to capture an image, or cause operation of an actuator in a specified manner.

Implementers are reminded to follow appropriate privacy practices and regulations. As described above, one aspect of the present technology is the gathering and use of data available from various sources for use in determining whether a person is authorized to use a device. As an example, such data may identify the user and include user-specific settings or preferences. The present disclosure recognizes that features such as robust authentication and user preference profiles can enhance the user's experience of electronic device. To the extent that implementations utilize identifying or personal information, which can be differentiated, entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such use should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile for customizing operating of a transport device, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon using the electronic device or downloading an app that their personal information data will be accessed and then reminded again later.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., legal names, etc.), controlling the amount or specificity of data stored (e.g., collecting gait information that is plainly visible rather than other biological data), controlling how data is stored (e.g., encryption), and/or other methods.

What is claimed is:

1. A non-transitory computer-readable storage device including program instructions executable by one or more processors that, when executed, cause the one or more processors to perform operations, the operations comprising:
obtaining sensor information from one or more sensors of the mobile device;
analyzing the sensor information to determine a first identifier for a person;
determining whether the person is authorized to use the mobile device based on a comparison of the first identifier to previously stored authentication information; and
in response to determining that the person is authorized to use the mobile device, outputting a recognition indicator.

2. The non-transitory computer-readable storage device of claim 1, wherein the recognition indicator is output according to customization information that is stored in a user profile that is associated with the person.

3. The non-transitory computer-readable storage device of claim 1, wherein outputting the recognition indicator includes outputting at least one of an audible indicator or a visible indicator.

4. The non-transitory computer-readable storage device of claim 1, wherein outputting the recognition indicator includes causing motion of a body of the mobile device.

5. The non-transitory computer-readable storage device of claim 1, wherein outputting the recognition indicator includes transmitting a recognition signal to a user device that is associated with the person.

6. The non-transitory computer-readable storage device of claim 1, further comprising:
analyzing the sensor information to determine a second identifier for the person, wherein determining whether the person is authorized to use the mobile device is based further on a comparison of the second identifier to the previously stored authentication information.

7. The non-transitory computer-readable storage device of claim 6, wherein the first identifier is a biometric identifier, and the second identifier is a non-biometric identifier.

8. The non-transitory computer-readable storage device of claim 6, wherein the first identifier is a first biometric identifier, and the second identifier is a second biometric identifier.

9. An apparatus, comprising:
a memory; and
one or more processors that are configured to execute instructions that are stored in the memory, wherein the instructions, when executed, cause the one or more processors to:
obtain sensor information from one or more sensors of the mobile device;
analyze the sensor information to determine a first identifier for a person;
determine whether the person is authorized to use the mobile device based on a comparison of the first identifier to previously stored authentication information; and
in response to determining that the person is authorized to use the mobile device, output a recognition indicator.

10. The apparatus of claim 9, wherein the recognition indicator is output according to customization information that is stored in a user profile that is associated with the person.

11. The apparatus of claim 9, wherein the instructions cause the one or more processors to output the recognition indicator by outputting at least one of an audible indicator or a visible indicator.

12. The apparatus of claim 9, wherein outputting the recognition indicator includes causing motion of a body of the mobile device.

13. The apparatus of claim 9, wherein outputting the recognition indicator includes transmitting a recognition signal to a user device that is associated with the person.

14. The apparatus of claim 9, further comprising:
analyzing the sensor information to determine a second identifier for the person, wherein determining whether the person is authorized to use the mobile device is based further on a comparison of the second identifier to the previously stored authentication information.

15. The apparatus of claim 14, wherein the first identifier is a biometric identifier, and the second identifier is a non-biometric identifier.

16. The apparatus of claim 14, wherein the first identifier is a first biometric identifier, and the second identifier is a second biometric identifier.

17. A method, comprising:
obtaining sensor information from one or more sensors of the mobile device;
analyzing the sensor information to determine a first identifier for a person;
determining whether the person is authorized to use the mobile device based on a comparison of the first identifier to previously stored authentication information; and
in response to determining that the person is authorized to use the mobile device, outputting a recognition indicator.

18. The method of claim 17, wherein outputting the recognition indicator includes outputting at least one of an audible indicator or a visible indicator.

19. The method of claim 17, wherein outputting the recognition indicator includes causing motion of a body of the mobile device.

20. The method of claim 17, wherein outputting the recognition indicator includes transmitting a recognition signal to a user device that is associated with the person.
